(19) United States
(12) Patent Application Publication
(10) Pub. No.: US 2016/0201231 A1
(43) Pub. Date: Jul. 14, 2016

(54) RENEWABLY SOURCED YARN AND METHOD OF MANUFACTURING SAME

(71) Applicant: Dennis Lenz, Hopkins, MN (US)

(72) Inventor: Dennis Lenz, Hopkins, MN (US)

(21) Appl. No.: 14/593,434

(22) Filed: Jan. 9, 2015

(51) Int. Cl. D02G 3/04; D01F 6/62; B29D 99/00; D01D 5/08; D02G 1/00; D02J 13/00

(52) U.S. Cl. CPC D02G 3/042; D02G 1/00; D02J 13/00; B29D 99/0078; D01D 5/08; D01F 6/625; B29K 2067/046

(57) ABSTRACT

A method for manufacturing a yarn from a plurality of polylactide pellets begins with the step of melting the plurality of polylactide pellets to form liquid polylactide. The liquid polylactide is extruded through an opening to form a fiber. The opening through which the liquid polylactide is extruded is less than three denier wide in diameter. A plurality of fibers that have been extruded are spun together to create the yarn.

### BACKGROUND ART

1. Field of the Invention

The invention relates to yarn that is produced from a renewable source. More particularly, the invention relates to a yarn and a method to fabricate the yarn from a renewable source.

2. Description of the Related Art

Fabrics have been woven from many different materials, some of which are natural and some of which are synthetic. Wools and cottons are naturally occurring materials that are used to create yarn, which is woven into a fabric. Nylon, rayon, polyester and the like are synthetic materials capable of being produced in the form of a yarn for which the yarn may be woven into a fabric. While each of these materials used to create fabrics have different qualities and characteristics, each is valuable for particular styles and/or characteristics needed for a particular function of the fabric. For purposes of this disclosure, the fabrics may be used to create bedding, towels, clothing, blankets, banners, flags, sails, tarps and the like.

Until recently, man-made or synthetic fibers used to create yarns for fabric were all made from non-renewable resources, primarily petroleum. Use of petroleum to create fabrics is not desirable for several reasons. Some of these reasons include, but are not limited to, the reliance on imported petroleum, the depletion of petroleum, the performance of fabrics created by petroleum, and the disposal of these products after their useful life has expired.

Recently, a natural based fiber, derived entirely from sustainable agricultural resources has been produced. This natural based fiber is produced from the sugars created by any number of plants. The sugars are fermented and the fermented sugar is transformed into polylactide, a polymer. A common polylactide is sold under the trademark Ingeo™, produced by NatureWorks, LLC out of Minnetonka, Minn.

Products have been made from the Ingeo™ polylactide polymer. However, these fabrics are lacking in the refinement in that they are not capable of being produced at such a quality that would find mass appeal in the general market. Therefore, there is a need in the art for a synthetic yarn produced from a renewable source having the quality commensurate with that which is currently found in the marketplace to render the fabrics created by these synthetic yarns appealing the marketplace.

### SUMMARY OF THE INVENTION

A method for manufacturing a yarn from a plurality of polylactic pellets begins with the step of melting the plurality of polylactic pellets to form liquid polylactide. The liquid polylactide is extruded through an opening to form a fiber. The opening through which the liquid polylactide is extruded is less than three denier wide in diameter. A plurality of fibers that have been extruded are spun together to create the yarn.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a logic chart of one embodiment of the inventive method;

FIG. 2 is a perspective view of equipment used to draw extrusion lines;

FIG. 3 is a perspective view of equipment used to spin fiber;

FIG. 4 is a perspective view of equipment used to crimp fibers;

FIG. 5 is a perspective view of equipment used to heat set the crimped fibers;

FIG. 6 is a cross-sectional view of a yarn incorporating one embodiment of the invention;

FIG. 7 is a side view, partially cut away, of a yarn being crimped according to one embodiment of the invention;

FIG. 8 is a graph comparing tenacity as a function of percentage of extension for various fibers; and

FIG. 9 is a table comparing various physical properties of fibers.

### DETAILED DESCRIPTION OF THE PREFERRED EMBODIMENT

Polylactide (PLA) resins are produced from renewable sources, namely plants that produce sugar in relatively high percentages. There are two types of PLA resins: D-enantiomers and L-enantiomers, that when combined, may form a stereoisomer. Unlike many commercial PLA resins, the PLA resin used in the invention disclosed herein only utilizes the D-enantiomer, to the exclusion of the L-enantiomer. The D-PLA resin is used because it is more suitable for thermal forming and less likely to crystallize during processing steps that include heating.

The method for manufacturing the yarn includes the use of a plurality of PLA pellets 10. In the preferred embodiment, the PLA pellets used include those produced by NatureWorks, LLC of Minnetonka, Minn. under the trademark Ingeo™. In particular, the invention incorporates the use of Ingeo™ Biopolymer 6100D and the specifications for this product are set forth in NatureWorks, LLC Technical Data Sheet, the information of which is incorporated into this disclosure.

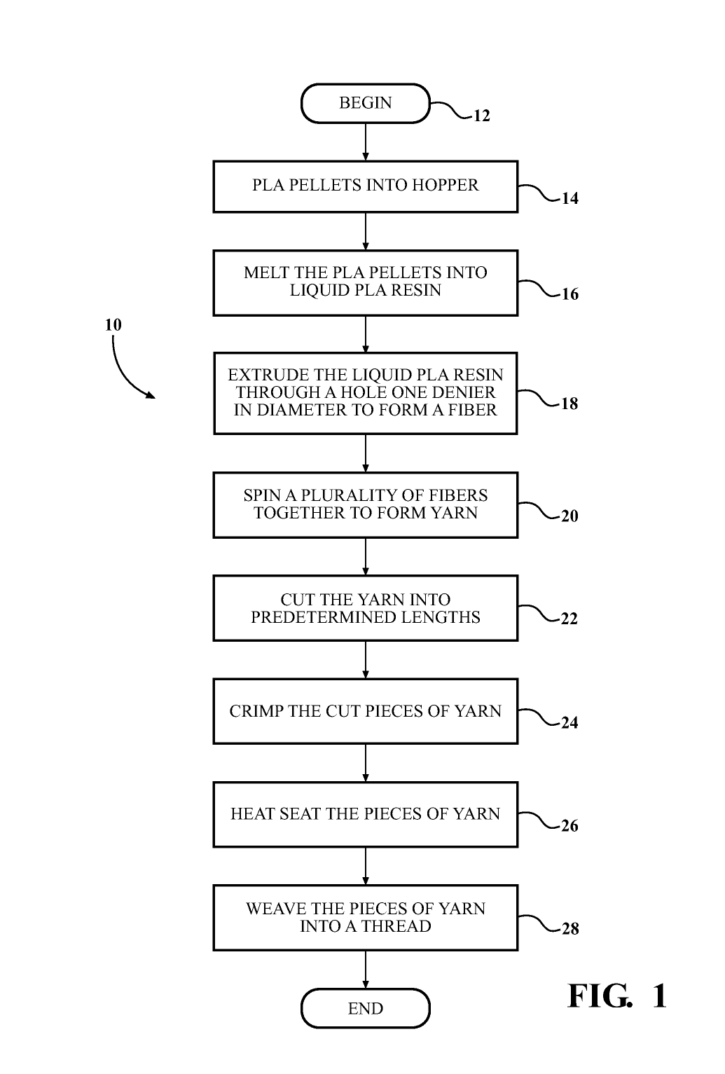

Referring to FIG. 1, a logic chart of one embodiment of the inventive method is generally indicated at 10. The method begins at 12. The method includes placing the plurality of PLA pellets into a hopper at 14. The PLA pellets are then melted to form liquid PLA resin at 16. In order to heat the PLA pellets allowing them to reach liquid PLA resin, the temperature in the hopper is raised in excess of 410° F. The liquid PLA resin 14 is then extruded through an opening to form a fiber at 18. A plurality of these fibers are spun together to create yarn at 20.

One of the difficulties in using PLA resin to create yarn to be used in fabric is that the resulting yarn cannot be successfully woven into a fabric due to inconsistencies created by the fiber. This characteristic of the fiber is eliminated when the extrusion process includes extruding the liquid PLA resin through an opening having a diameter less than three denier wide. In a preferred embodiment, the diameter of the opening through which the PLA resin is extruded is approximately one denier. The opening through which the fiber is extruded is circular in shape.

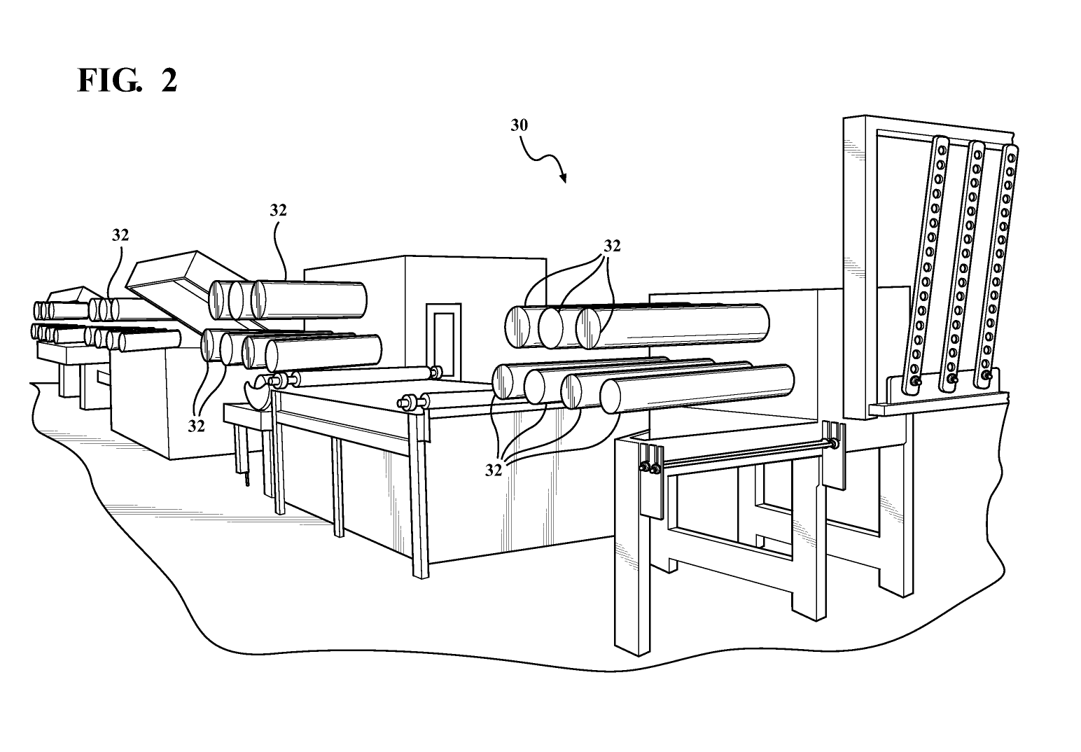

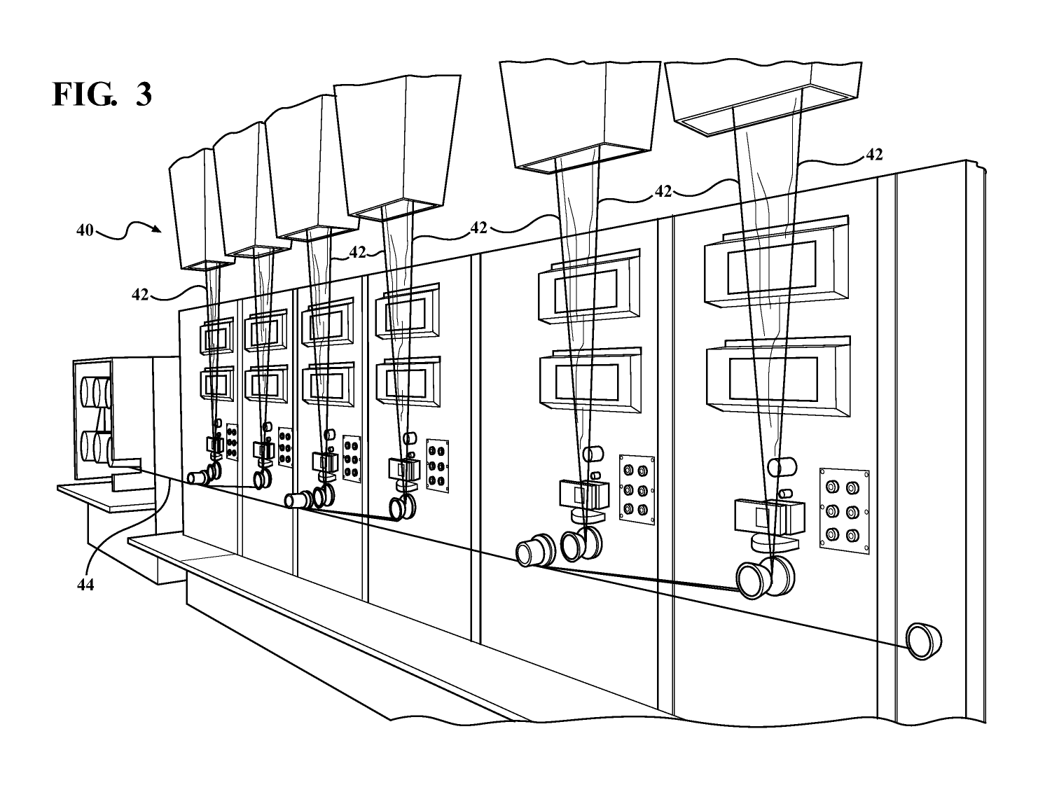

Referring to FIG. 2, a perspective view of equipment used to draw the fibers is generally shown at 30. Fibers are stretched and wrapped around rollers 32. In FIG. 3, a perspective view of equipment used to spin the fibers into yarn is generally shown at 40. The fibers 42 are passed over spindles 44 that combine fibers 42 for the combination of those fibers 42 into a yarn 44.

Immediately following the extrusion of the fiber 18 from the hopper 12, the fiber 18 is cooled. While a defined cooling process (air jet, reduced ambient temperature room, etc.) may be used to assist in certain circumstances, it is not contemplated that much assistance is needed as the fiber is so thin, it rapidly cools once it leaves the hopper.

The fiber is then cut to a predetermined length to create a plurality of cut fibers at 22. The predetermined length varies based on the type of fabric in which the yarn is going to be used. For example, if the yarn is going to be used for carpet or bedding sheets, the predetermined length will be approximately 38 millimeters. It may be appreciated by those skilled in the art that the variance in the predetermined length of the plurality of cut fibers are determined by the design of the fabric being produced.

Once a plurality of cut fibers have been created, each of the plurality of cut fibers is crimped at 24 using crimping equipment 50. This is graphically shown in FIG. 7 wherein a crimping tool 50 is shown creating a crimp 52 in a plurality of cut fibers 54 that make up a piece of yarn, generally shown at 56. The crimping of each of the plurality of cut fibers results in crimps 52 spaced apart from each other along the length of the cut fibers 54. The crimping is done multiple times for each piece of the plurality of cut fibers 54. In one embodiment, the cut fibers 54 include five crimps 52. In a preferred embodiment, the cut fibers 54 are crimped at least ten times per inch.

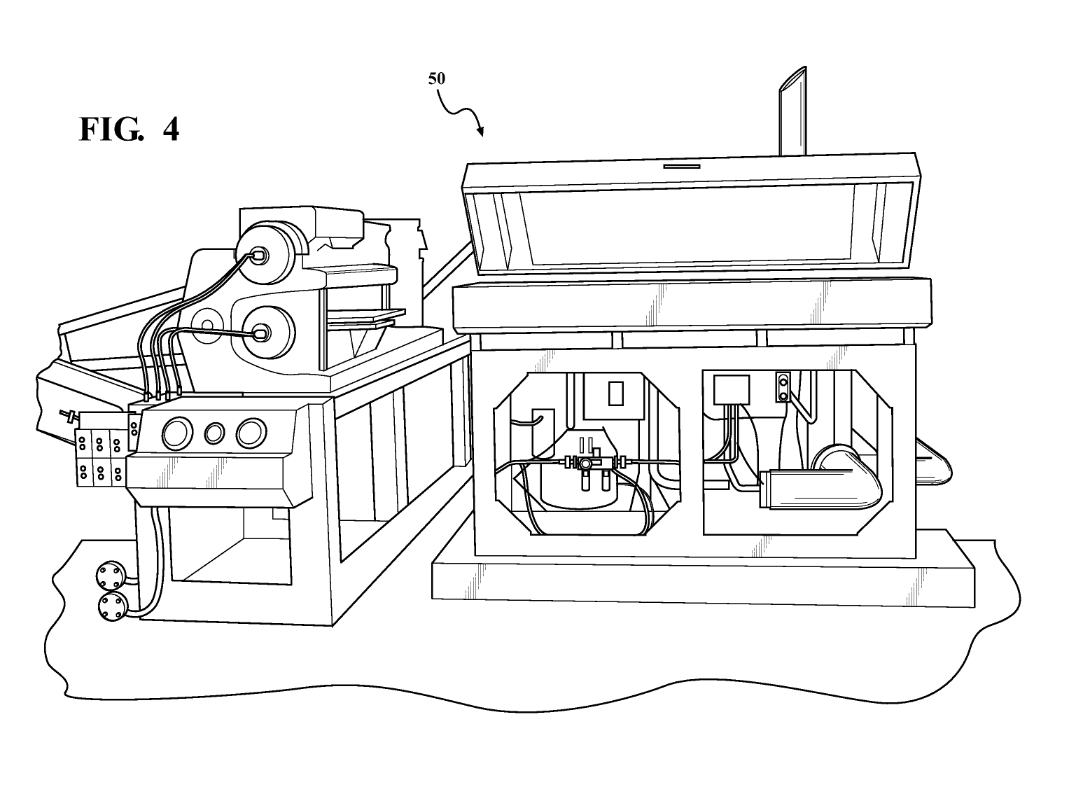

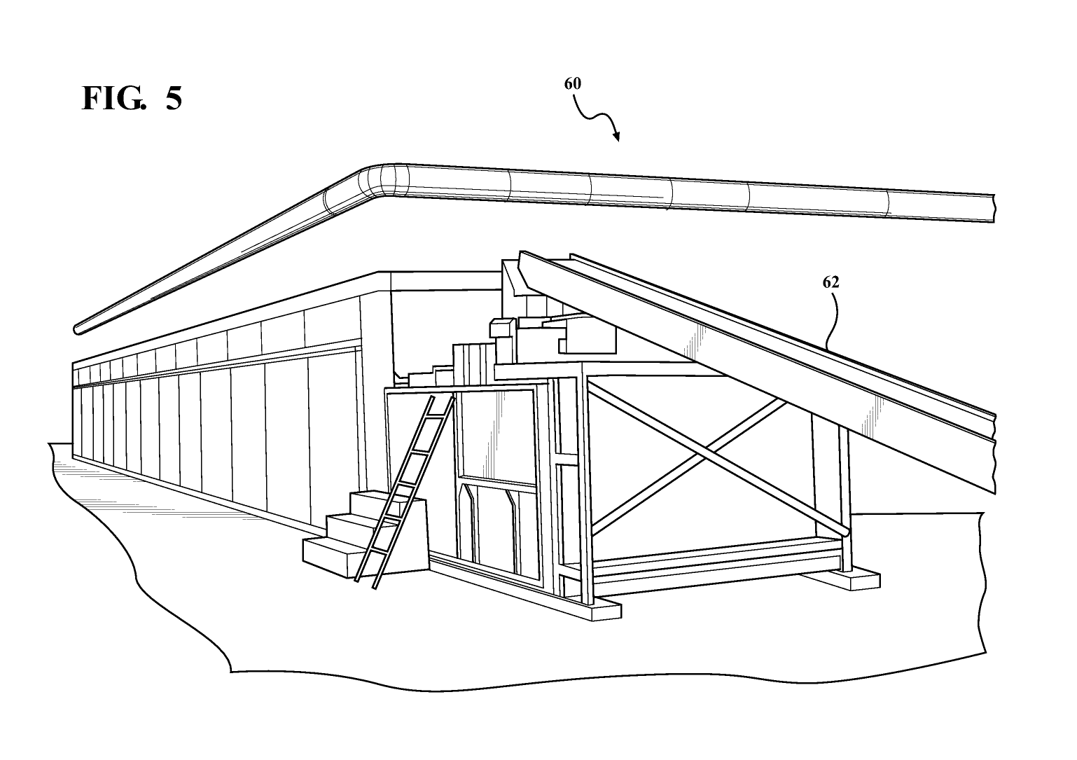

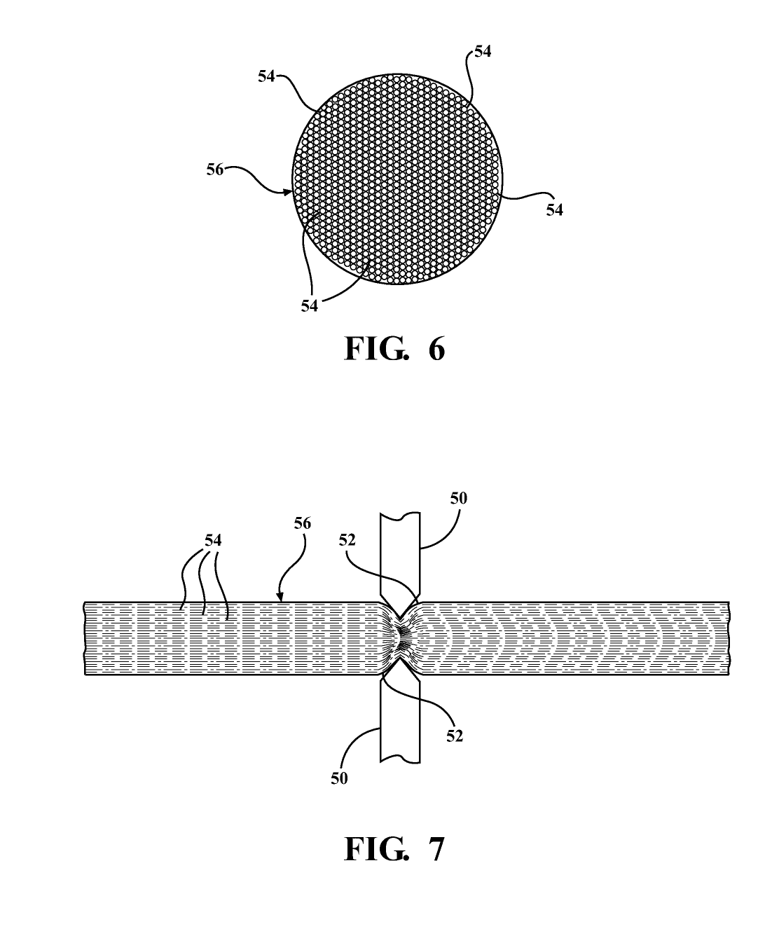

Once crimped using the crimping tool, graphically shown in FIG. 7 as 50 and generally shown in FIG. 4, the yarn is finally treated by a heat setting operation using equipment generally indicated at 60 in FIG. 5. The heat setting operation 26 (FIG. 1) receives the pieces of yarn into the heat setting equipment 60 via a conveyor 62. After the pieces of yarn are heat set, they are woven into thread at 28.

Fibers made from Ingeo™ are produced with 68% less energy than fibers produced using other synthetics. Less energy consumption translates into fewer greenhouse gases emitted into the atmosphere, which will lessen any adverse impact on the atmosphere by its production.

Fabrics that use the above-described yarn 56 have wicking properties superior to other synthetic materials. A test with strips of needle-punched non-woven fabric made with the yarn 56 was performed against fabric made from polyester (PET). The strips, machine direction (MD) and cross-machine direction (CD) were dipped into a glass filled with colored water to measure the movement of the water in the fabric. Measurements were taken at 5, 20, 30, 40, 60 and 120 minutes. The average wicking height, in inches after 120 minutes for the yarn 56 was 100% greater than that of the polyester in both unfinished and finished fabrics.

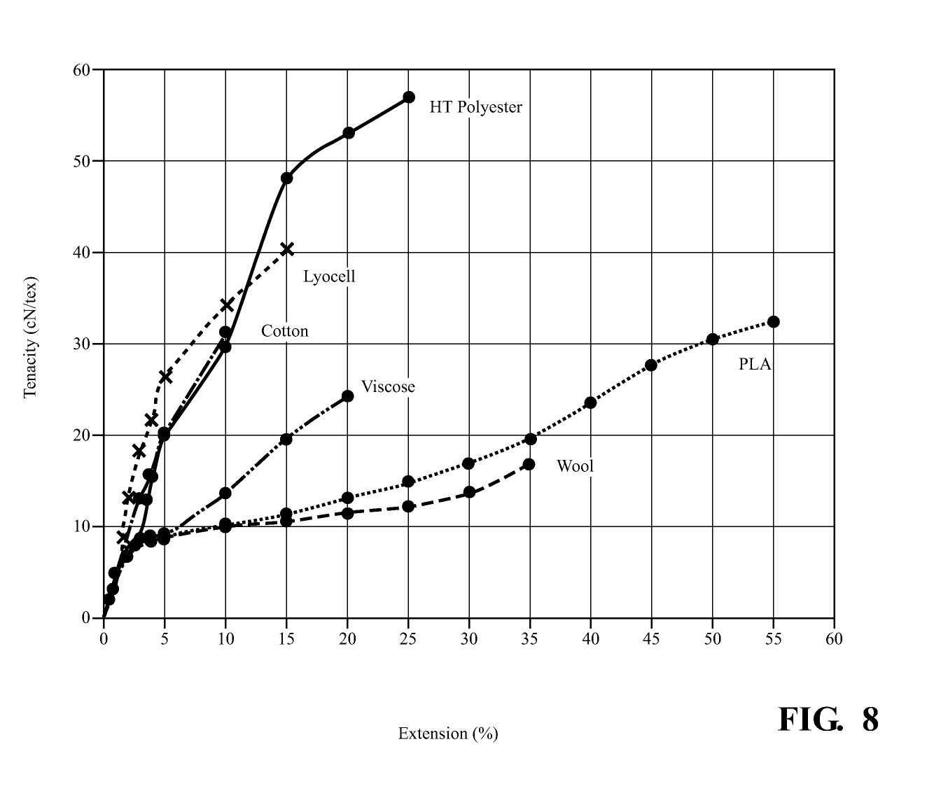

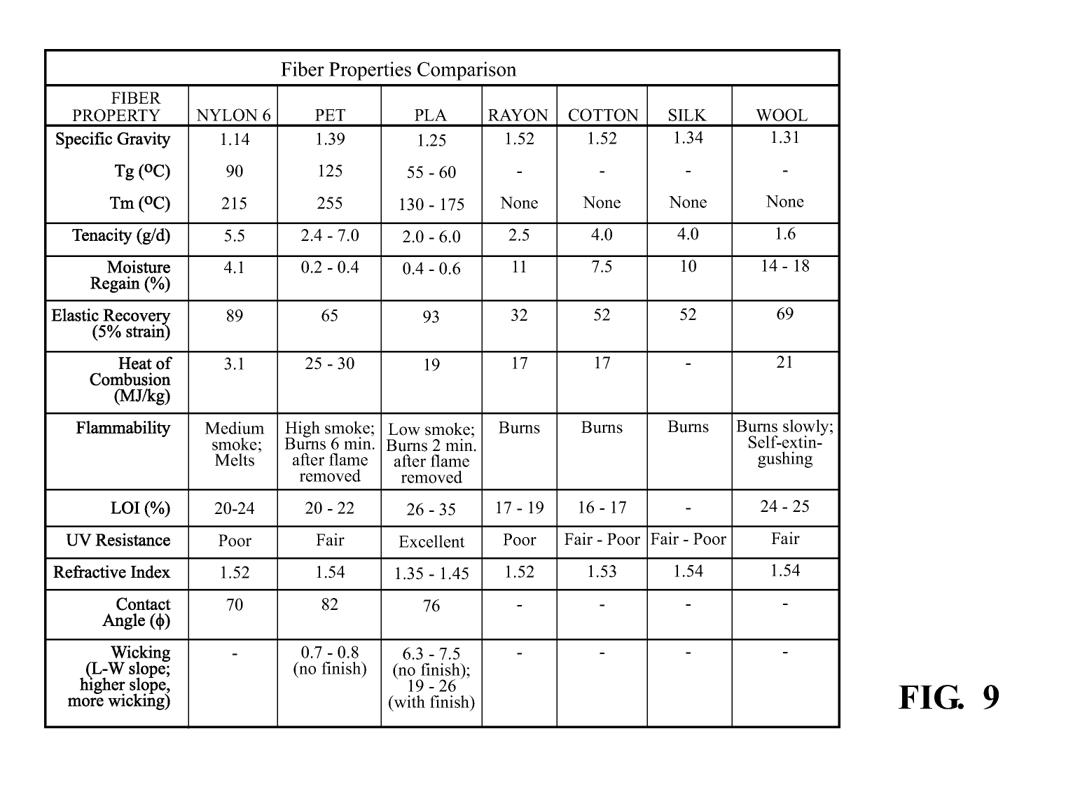

The fabric produced with the yarn 56 was also tested against various other natural fabrics to determine its relative strength. With 1.5 dtex 38 mm Ingeo™ PLA, the stress strain data set forth in FIG. 8 shows the yarn 560 is far superior relative strength due to its elongation properties as compared with the other nature fabrics tested.

Referring to FIG. 9, fiber properties of several materials are compared with PLA fibers used to create the yarn 56. The PLA fibers consistently perform better over most categories. In particular, the elastic recovery (at 5% strain) of the PLA fibers is far superior to all other fibers tested. The limited oxygen index percentage (LOI%) is higher than all of the other fibers tested.

One product that is produced using the yarn 56 is a towel. 100% of the yarn 56 spun and woven to form the towel uses its excellent wicking properties to quickly remove moisture from the object being dried. The moisture is quickly released from the towel during light drying because the yarn 56 does not absorb the moisture.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. A method for manufacturing a yarn from a plurality of polylactic pellets, the method comprising the steps of:
melting the plurality of polylactic pellets to form liquid polylactic;
extruding the liquid polylactic through an opening to form a fiber, wherein the opening is less than three denier wide in diameter; and
spinning a plurality of fibers together to create the yarn.

2. A method as set forth in claim 1 wherein the step of melting includes the step of raising the temperature of the plurality of polylactic pellets to a temperature in excess of 410° F.

3. A method as set forth in claim 2 including the step of cooling the fiber after it is extruded.

4. A method as set forth in claim 3 including the step of cutting the fiber a predetermined length to create a plurality of cut fibers.

5. A method as set forth in claim 4 including the step of crimping each of the plurality of cut fibers.

6. A method as set forth in claim 5 wherein the step of crimping each of the plurality of cut fibers includes the step of crimping each of the plurality of cut fibers at least five times.

7. A method as set forth in claim 5 wherein the step of crimping each of the plurality of cut fibers includes the step of crimping each of the plurality of cut fibers at least ten times per inch.

8. A method as set forth in claim 1 wherein the step of extruding includes extruding the liquid polylactic through an opening having a diameter less than two denier wide.

9. A method as set forth in claim 9 wherein the opening is circular in shape.

10. A method for manufacturing a yarn from a plurality of polylactic pellets, the method comprising the steps of:
placing a plurality of polylactic pellets into a hopper;
heating the plurality of polylactic pellets to a temperature in excess of 410° F. to form liquid polylactic;
extruding the liquid polylactic through an opening to form a fiber, wherein the opening is less than 1.3 denier wide in diameter; and
spinning a plurality of fibers together to create the yarn.

11. A method as set forth in claim 10 including the step of cooling the fiber after it is extruded from the hopper.

12. A method as set forth in claim 11 including the step of cutting the fiber every 38 mm to create a plurality of cut fibers.

13. A method as set forth in claim 12 including the step of crimping each of the plurality of cut fibers.

14. A method as set forth in claim 13 wherein the step of crimping each of the plurality of cut fibers includes the step of crimping each of the plurality of cut fibers at least five times.

15. A method as set forth in claim 14 wherein the step of crimping each of the plurality of cut fibers includes the step of crimping each of the plurality of cut fibers at least ten times per inch.

16. A method as set forth in claim 14 wherein the step of cooling includes the step of allowing the fiber to cool naturally using ambient temperature.

17. A method as set forth in claim 16 wherein the opening is circular in shape.

18. A yarn fabricated from a plurality of spun polylactic fibers less than 50 mm long, wherein each of the plurality of spun polylactic fibers has a diameter less than 3.0 denier.

19. A yarn as set forth in claim 18 wherein each of the plurality of spun polylactic fibers has a diameter equal to or less than 1.0 denier.

20. A yarn fabricated from a plurality of spun polylactic fibers less than 50 mm long, wherein each of the plurality of spun polylactic fibers has a diameter less than three denier, each of said plurality of spun polylactic fibers produced by:
melting the plurality of polylactic pellets to form liquid polylactic;
extruding the liquid polylactic through an opening to form a fiber, wherein the opening is less than three denier wide in diameter; and
spinning a plurality of fibers together to create the yarn.
